(19) United States
(12) Patent Application Publication
(10) Pub. No.: US 2014/0301724 A1
(43) Pub. Date: Oct. 9, 2014

(54) Electronic Heating of People and Animals

(71) Applicant: David Silliman Graham, Mountain View, CA (US)

(72) Inventor: David Silliman Graham, Mountain View, CA (US)

(21) Appl. No.: 13/858,043

(22) Filed: Apr. 6, 2013

(51) Int. Cl. H05B 3/00

(52) U.S. Cl. CPC H05B 3/0071
USPC 392/407

(57) ABSTRACT

A heater for human comfort and homeostasis is made by using a thermal laser. The heat from the thermal laser is pointed precisely with optics such as lenses and reflectors. The apparatus may be pointed with an automated pan-and-tilt. It may be targeted by a camera or similar sensor. It can turn its power levels up or down, or off, in response to the data from the sensor. The precision with which the source can be aimed leads to a higher proportion of photons hitting the target than with current heaters. This heater also maintains the power density of the photons impinging on the target or anything else within safety limits.

This application claims the benefit of PPA 61/621,749 filed Apr. 9, 2012.

### BACKGROUND OF THE INVENTION

1. Field of the Invention

This invention relates to heating people, other living things, and their surroundings for comfort and homeostasis.

2. Description of the Related Art

People use heaters to stay warm.

We also heat other living things, including animals and plants.

The current methods of heating fail into 3 families:
1) Conductive heating, which is how an electric blanket works;
2) Convective heating, which is how a furnace and fan work in central heating;
3) Radiative heating, which is how a patio heater works.

This invention relates to radiative heating. Radiative heating currently uses two primary technologies: 1) combustion of natural gas (methane), propane, coal, or wood; 2) electrical resistance heating. In both of these cases, the heat (photons) can only he pointed in a general direction, primarily because the photons are ejected from the heating material by spontaneous emission and because the heating material is necessarily too large to focus. The result of this imprecision is that much of the thermal energy these heaters put out usually does not hit a person or other target. As an example, assuming the thermal output of a radiative heater subtends 4π steradians, and a normal person with 1 square meter of frontal surface area stands 2 meters from the heater, he would receive about 2% of the thermal energy from the heater. A reflector can be used to point the heat generally in one direction, but a reflector is highly inaccurate and unlikely to improve the efficiency of a radiative heater beyond 4% at 2 m. The rest of the thermal energy would go to the person's surroundings. While a person may derive some comfort from the warm surroundings, the comfort they derive is out-of-proportion to the energy expended. Outdoors or where there is wind or a strong draft, the inefficiency is worse. This inefficiency is both expensive and bad for the environment.

Moreover, with existing radiant heaters, the target usually must move to a specific distance from the heater to be comfortable. Closer to the heater the target will be too hot and further away the target will be too cold. It is difficult to be comfortable when moving around.

Because existing heaters use combustion or resistance, their photons are spread across many wavelengths. They are large broadband sources with much of the power at relatively long wavelengths, and that power is headed in all directions. They cannot, therefore, take advantage of the precision that optics can provide with a small, relatively narrow-band emitter. At best, they can use large aluminum reflectors to try to change the direction in which the heat travels.

The cases or enclosures of existing heaters are also hot, which makes them unsafe. A person can burn himself touching them, or a fire can be started by a piece of paper touching them.

The existing broadband heaters emit light as well as heat, which some people consider distracting.

Microwave heating has been tested by the US military to heat people in order to stop them from approaching or to disperse crowds. These systems require large antennas, and their use of microwaves would tend to interfere with radio communications.

Until now, laser sources have not been used to heat people or animals for comfort or homeostasis. The physical properties of laser sources make them useful when it is desirable to focus heat for material processing. They have been used on human and animal tissues under focus not as heaters for comfort and homeostasis but as scalpels and medical tools. For example, http://en.wikipedia.org/wiki/Laser_medicine has an overview of the medical uses of lasers. These devices are not used to keep people warm and comfortable. They are generally hand-held but sometimes stationary, and the power densities are designed to cut tissues, remove hair or tattoos, or cure arthritis, but not to make a healthy person comfortable.

One example of this is the device from US Patent Application 20120089135, Laser Generator for Dep Tissue Laser Treatments Using Low Intensity Laser Therapy Causing Selective Destruction of Nociceptive Nerves. This device is not a heater designed far comfort but a medical device designed for nerve-therapy. It uses non-thermal wavelengths under 980 nm at powers of 1 mW-6 mW. 980 nm is not a thermal wavelength—the thermal wavelengths are longer than 1200 nm. Moreover 1 mW-6 mW is insufficient to heat a person.

Another example of a laser medical device is 20110218598, Stand-alone scanning laser device, which attempts to grow hair 635 nm.

None of these or any other device designed for therapy is a device that would keep a person or animal comfortable in a normal room or outdoors. In general, they are either at the wrong wavelengths, they output the wrong amount of power at the wrong power densities, and their optics do not allow them to be pointed with precision at a person across a few meters of space. As a source becomes less precise, it becomes less efficient and less cost-effective.

These devices do not safely send heat out into occupied space at power densities suitable for the comfort and homeostasis of people and other living things. These systems have no targeting and feedback mechanism suitable for heating people and no software suitable for safely heating people. Moreover, their optics are unsuited to the task. In particular, usually their optics attempt to focus the beam, rather than to collimate it and transmit a relatively uniform beam over a distance.

### SUMMARY

One aspect of the present invention is the use of a thermal laser or RCLED to heat people or animals for comfort and homeostasis. Another aspect is the use of optics that shape the beam so that much of the power impinges on a target across a room, and the power density is within safety limits. Another aspect is the use of a camera or other sensor to determine the position of the target person or other target. Another aspect is the use of a mechanism such as a pan-and-tilt to allow the laser to point the heat at a target at many positions within a field of view, or to track a target if it moves. Another aspect is the use of an algorithm to select and track targets. Another aspect is to respond to feedback from targets, including control instructions. Another aspect is the use of ambient temperature and wind sensors that provide information to an algorithm that can decide how much heat will be comfortable to the target. Another aspect is the use of additional sensors to assure that the beam will not touch a person at any point in space where it is above safety limits.

In one embodiment, the system is a heater with a thermal laser diode source (or sources) and optics to shape the beam. The beam should be shaped so that a large proportion of the photons impinge on the target and the power density is suitable for safety and comfort for a living thing.

In another embodiment, the system is a heater as above with a sensor (an imager) to identify targets, and it may have an automated system to point at a target.

For either of the embodiments above, the beam may be collimated or it may be allowed to expand to a desired size at a desired position. In either case, electronics may be used to keep the power density in the beam within a safety limit when it touches a person, even though the power density may exceed the limit in other places. A time-of-flight sensor, binocular camera, or other distance sensor may give the distance to the target as well as possibly the distance to something else that may be entering the beam.

In any embodiment, the heater can be controlled by the target. This can be done with a controller, like those used for televisions, or it can be done by gestures picked-up on the position sensing camera or other sensors.

In the second embodiment above, the heat beam system can distinguish between a target human's exposed skin and their clothed skin, warming the two in different amounts, or perhaps only warming the exposed skin.

In any embodiment, the heat beam system has sensors for ambient temperature and wind to provide input to the algorithm that decides what the beam intensity should be at the target. It may also have a thermal camera to determine the temperature of a person or some object that they may come in contact with.

In the second embodiment, the system can coordinate multiple beams heating one or multiple targets. For this communication between heaters, such as by radio, is required.

In another embodiment, a mirror can be used to redirect a beam. The mirror may be similar to those described in U.S. provisional patent application Ser. No. 60/828,581 entitled “Mirror for Power Beaming,” filed Oct. 6, 2006.

A heater of this type has a number of advantages over existing heaters. First, it is far more efficient because a far larger proportion of the emitted photons strike the target. Also, it is more comfortable because it can more precisely determine the power density of the heat that strikes the target. Also it is safer because its case is cool rather than hot and no person can be exposed to heat above a safe limit.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 shows the spectrum of the sun.

FIG. 2 shows the black body curves for several temperatures

FIG. 3 shows the regulated limits for Class 1M under IEC-60825-1.

FIG. 4 is an illustration of a schematic of a system, in accordance with one embodiment.

FIG. 5A shows outline drawings of the device, while FIG. 5B shows the same device with dashed-tine views.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

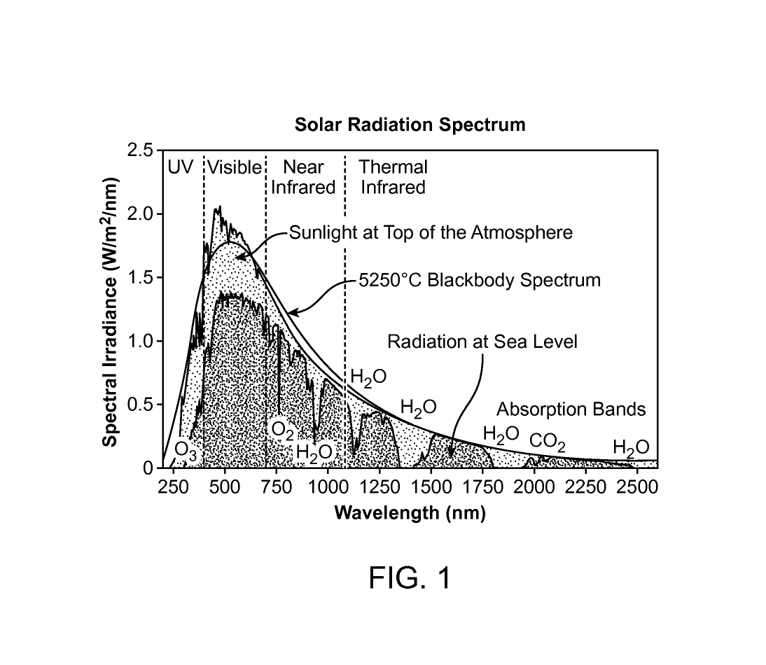

FIG. 1—INFORMATIONAL—shows the solar spectrum. What is light and what is heat? Both are photons. The only difference is wavelength. Light is the part Mat the human eye can see. Heat is the longer wavelength infrared photons that the cornea cannot focus and that the rods and cones are not sensitive to. Human vision occurs at the peak of the sun's emission.

The sun is approximately a 5,500° K emitter. At the earth's surface it outputs about 1 kW/sq. m. Much of its output is in the visible and not the thermal infrared, and in this sense it is a less than ideal heater. Because the human body evolved to be sensitive to light but insensitive to heat, safe levels of heat are orders of magnitude higher than safe levels of light.

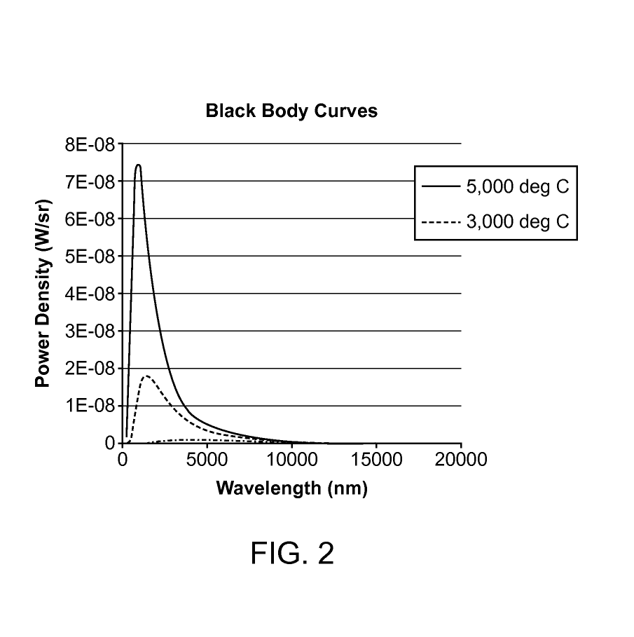

FIG. 2 Black body curves for several temperatures—INFORMATIONAL

As heaters move to lower temperatures, they do not have as sharp a wavelength peak, and the peak moves toward longer wavelengths. Combustion heaters and resistance heaters approximate a black-body curve. For example, a natural gas radiant heater will approximate the 1000° C. black body curve. This is a very broadband source.

Semiconductor devices, such as lasers, are band-gap emitters. Their emission is over fewer wavelengths. A thermal laser will have more than 95% of its power within 10 nm. A narrow band source, like an LED or laser, is useful because refractive optics, including plastic refractive optics, can be used. They cannot, in general, be used with broadband emitters like heating elements. To understand this difference, consider the milky white optic on the front of a motion detector that operates at approximately 10,000 nm in contrast to the clear optic on the front of a flashlight that operates at less than 1,000 mn. Also, a narrow band heat source will emit no visible light, but a black body source will. Some people complain about this as an inconvenience, but it is also a safety matter, as the eyes are much more sensitive to light than to heat. A thermal laser will also have much higher brightness than the usual sources for heaters. This is a property of bandgap emitters and especially lasers as opposed to combustion or resistance heating. Basically, you get more photons per steradian from a bandgap emitter by stimulated emission than from a black body source. In fact, the power density at the front facet of a laser exceeds that of a combustor or a resistance device because of the basic physical limits of the materials that burn gas and the stoichiometry as well as the basic limits of the resistive materials. Because the front facet can be so small for a given power density, it is much more efficient to image.

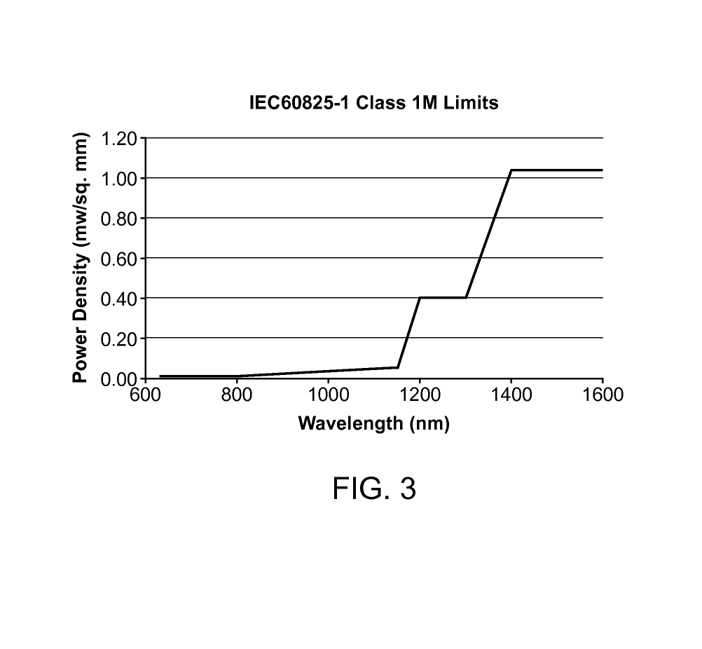

FIG. 3. Regulated limits under IEC60825-1—INFORMATIONAL This curve shows the regulated limit for exposure to lasers at Class 1M under IEC 60825-1. it shows the transition from visible light to heat. In the visible and near infrared, the exposure limits are approximately 0.01 mW/sq. mm. At 1400 nm where the limits are 1.04 mW/sq. mm. This is approximately the same as the power density outdoors at midday in sunlight.

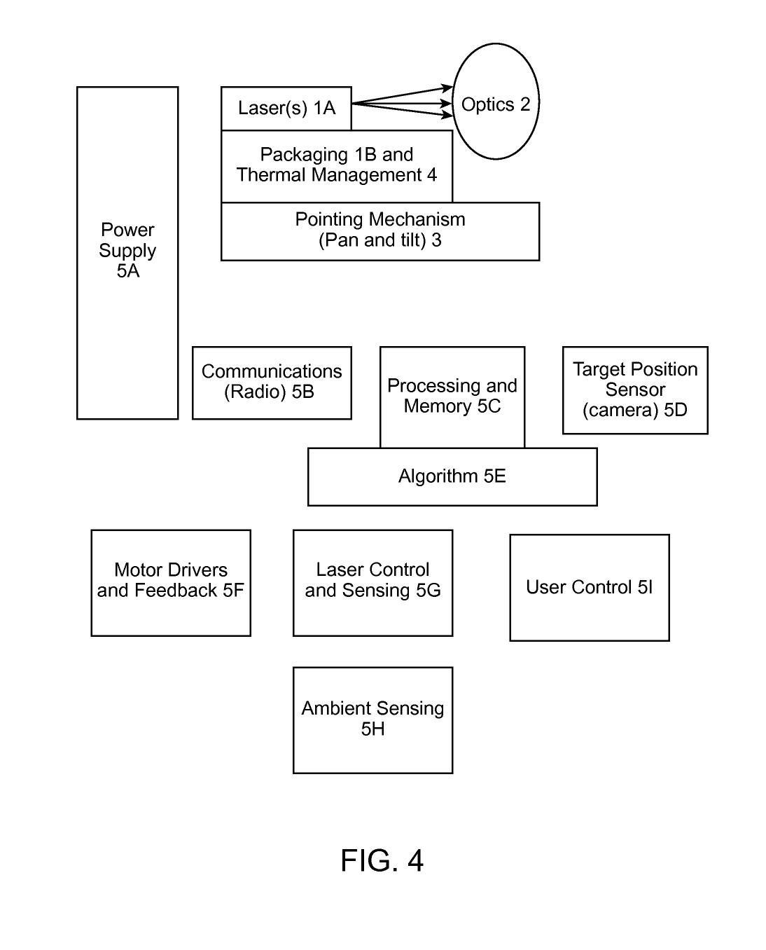

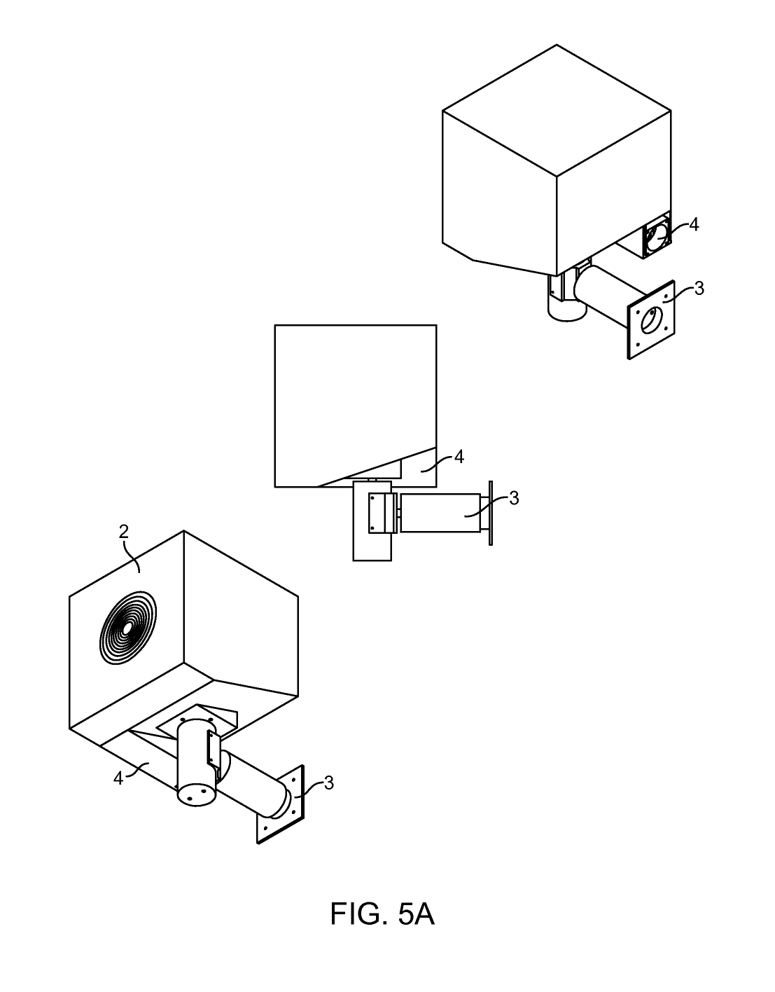

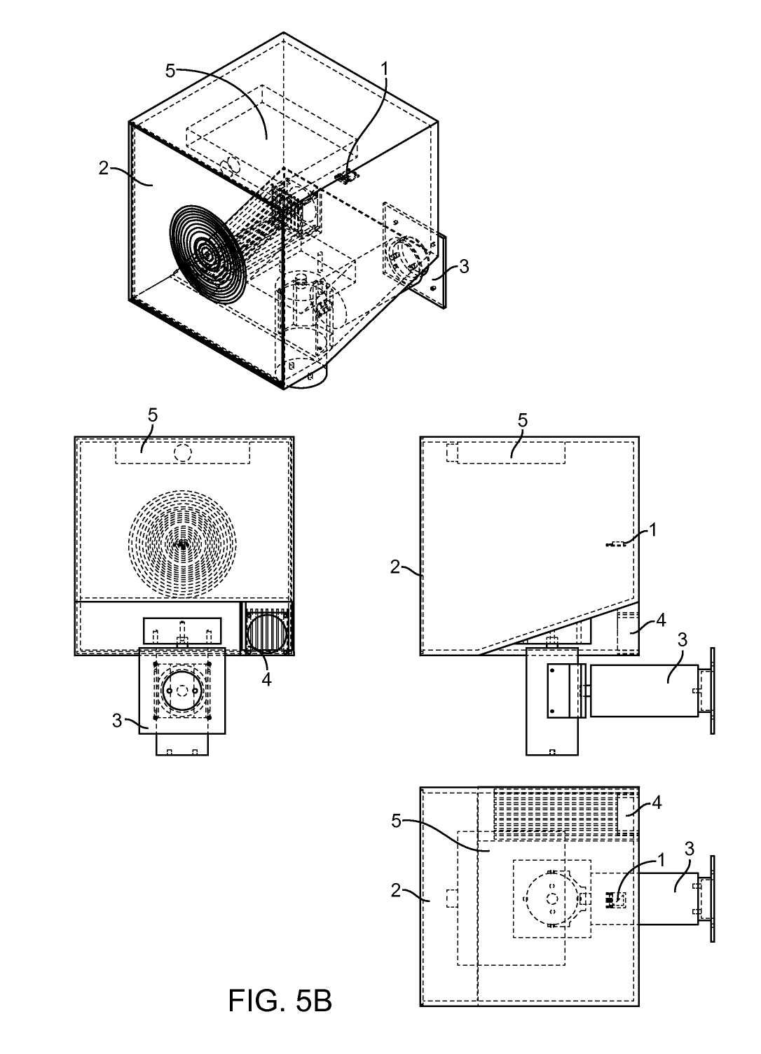

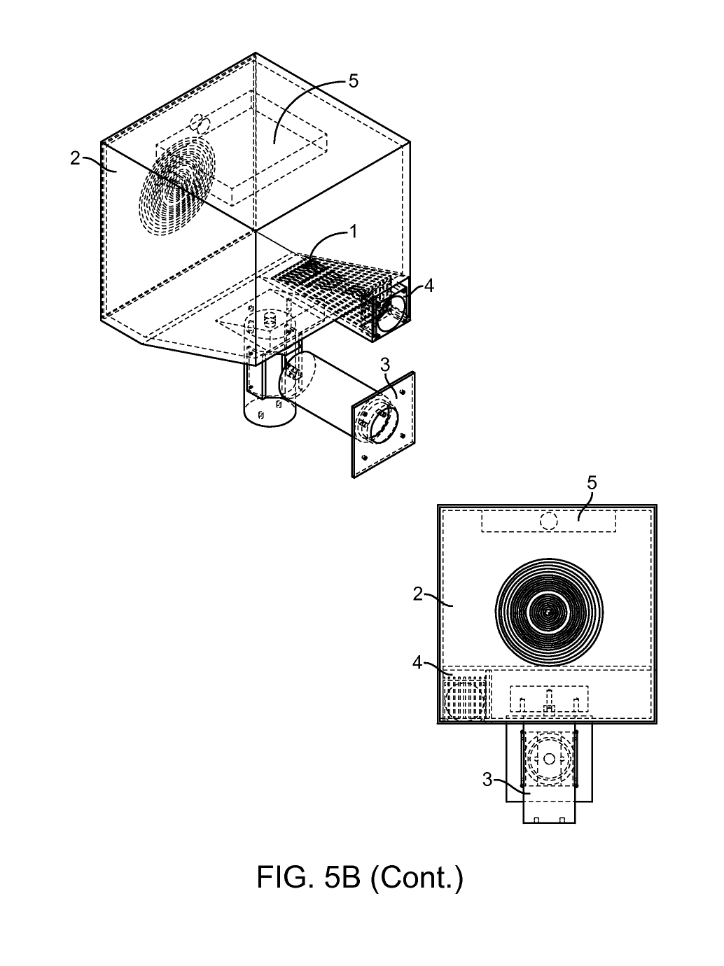

FIG. 4. System Schematic

The Thermal Laser(s) 1A may be of many types, and a good solution is an array of InGaAs on InP laser diodes operating at 1400-1600 nm. These operate at an eye-safe point in the spectrum, and they feel warm to the skin. They have no ultraviolet light, as sunlight does, and therefore are unlikely to cause skin cancer or sunburn. Their power outputs and efficiencies vary. Examples are a 5 W emitter from Seminex at 1480 nm that is 20% efficient and a 1.5 W emitter from nLight that is 32% efficient. These can be procured at a reasonable cost. These are available from companies such as Oclaro, JDSU, Seminex, and others. Other laser systems, such as CO2 lasers, might also be used. Resonant cavity LEDs might also be used, as they function on a principle similar to lasers, but no vendor appears to make them at thermal wavelengths.

The power output of these is decided by the size of the spot and the maximum desirable output. Two levels of maximum output may be desirable: In compliance with safety limit throughout the beam; above the safety limit at points within the beam, but below the safety limit at any point where a person may come into contact with the beam.

An example of the first case is a system designed to output a maximum desirable power of 1 mW/sq. mm, which makes this a Class 1M device. If we desire to heat a spot 300 mm×300 mm—larger than a person's head—we will require a peak power of 90 W. The power can be reduced by reducing or modulating the input current. Modulation is usually better because it allows the thermal laser to operate at the most efficient point on its power curve.

An example of the second case is a system that must provide 1 mW/sq. mm at a distance of 40 meters. Because of limits on how well the beam can be captured by a lens, experience teaches that the beam falls-off at approximately 1% per meter. If every point in the beam was within the Class 1M limit, the maximum power on a target at 40 m would be approximately 0.6 mW/sq. mm. For comfort outdoors in the wind, a higher level of heat is more desirable. in this case, it would be possible to have 1.7 mW/sq.mm enter free space from the system, and to use electronics to turn down the beam if something began to enter it at a point where the power density exceeded the safety limit. A 300 mm×300 mm spot would require 153 W.

In either case 1 or case 2, the lasers must launch more than 90 W or 153 W respectively. Laser divergences are usually specified at full width half max (FWHM). Laser powers are specified including power that is beyond the FWHM. As a result, if the optics are designed for the FWHM, only ⅔rds of the power will couple into the optics.

Packaging 1B can be done in several ways. They can be coupled into a fiber bundle or combiner or a waveguide array. A common problem with high power laser diodes is that the fast axis is approximately 30 degrees FWHM, and the slow axis is approximately 5 degrees. The beam is very ellipsoidal. The source is single-mode in the fast axis and very multimoded in the slow axis. In some cases, microlenses to circularize the beams like those made by Blue Sky Research can be included within the package, but these add expense and sometimes require a diverging lens to follow. Also, their beams can be coupled in free space, using a coupler such as those sold by Ingeneric. Some feedback in the system can be provided for safety, such as from monitor photodiodes.

It is critical that the Thermal Management 4 be effective. One choice is to a microchannel cooler attached to a radiator and fan. The microchannel cooler sits immediately under the laser diode array, individual laser diode, or either's submount. The radiator and fan require a pump. A cheaper, simpler solution might be heat pipes with a fan, but the performance of this solution will vary across ambient temperature. Thermoelectric coolers (TECs) may also be used.

Optics 2 to to shape the beat are important. A good choice is a Fresnel lens because it is relatively thin, light, and cheap. These can be made in glass or plastic. Glass will efficiently pass most wavelengths longer then 1400 nm, but it is more expensive than plastic. It is also generally easier to clean. If plastic is used, it is necessary to look at the transmission curves carefully, as many plastics are highly absorptive from 1400 nm to approximately 1480 nm. Exceptions include fluoridated plastics, such as PTFE (Teflon). Collimation is convenient because it assures that whether a person receives the same amount of heat at many different distances from the heater. As a result, unlike current heaters, a person is guaranteed to be appropriately warm at any distance from the heater. When collimating, it is necessary to be aware of the power density at the beam waists, which is the place where power density may be highest. It may not be desirable to have a focus for the beam in free space, as it is difficult to make a point of high power density safe.

Lenses such as plano convex spirical lenses can he used to expand the beam and shorten the enclosure.

Fixed lenses are simple and effective. For some cases, especially long distance cases, an arrangement of moveable lenses may be desirable.

It is best to antireflection coat all optical surfaces. Other arrangements can be used, but in any arrangement the critical parameter is that the power density at the target must be both useful and safe.

Reflectors can be used in addition to and sometimes instead of lenses. For example, off-axis parabollics can be used for collimation.

The Pointing Mechanism 3 must have sufficient resolution to hit the target at the desired range. Two axes of stepper motors with geardown are shown. The pointing mechanism should have sufficient speed to scan over some part of a target or between targets. For example, it may be desirable to heat a person's face 75% of the time and their shirt 25% of the time, or it may be desirable to timeshare one heater among two people.

The Position sensor (5D) can be of many types. To the extent that the beam is collimated, it is not necessary to know the depth of the target, but only the pan-and-tilt coordinates required to hit it. A standard CMOS camera such as those made by Aptina or Omnivision is a good choice. Many standard optics can be used. Algorithms for detecting targets in the images may vary. For example, many H.2634 encoders have head tracking. The TI Davinci line of media processors implements this in hardware. It may be desirable to use a thermal camera or thermal diode to detect the heat from people's bodies. If the sensor's field-of-view is less than the field through which the heater can be rotated, it will be necessary to move the sensor through the heater's field to avoid losing coverage. When multiple heaters will be used, cost can be saved by putting the position sensor outside any one heater and communicating its output to multiple heaters.

Because there may be multiple targets and multiple heaters in one place, it is useful to have Communications 5B between the heaters to coordinate which heater heats which target from which angle. It may also be useful to aim multiple heaters at one target, so for example a person might be heated both on their face and on the back of their head. Standard FSK or ASK radios can be conveniently used, as can more sophisticated radios. Other means of communication, such as IRDA are not excluded. If each heater has a photodiode that is sensitive at its heating wavelength, the heater lasers themselves can be used to communicate.

Processing and Memory 5C can be many arrangements of CPUs and memory. The software that will run on the CPU should be able to 1) detect targets, 2) aim the laser(s) at targets, and 3) control the electricity to the laser and thus the power from it and onto the target. It may also 4) take user input from the target.

Motor Drivers and Feedback 5F are the drivers for the Pan and Tilt mechanism and the limit and home sensors. These are off-the-shelf electronics.

Laser Control and Sensing 5G is photodiodes and temperature sensors that tell the CPU and Algorithm what the actual output of the lasers is. Because lasers' outputs change with temperature and time, it is useful to measure them in service. The photodiodes can be inside the laser packages, but often they are not. They generally require a transimpedence amplifier for readout. If the lasers go above a safe current level, it is best that they cut-off automatically, such as on a timer. As long as they are within specification, the CPU can periodically reset the timer.

Ambient Sensors 5H are: 1) a temperature sensor like a thermistor or other similar sensor that senses ambient temperature, 2) a wind sensor like a pressure sensor or pilot tube that senses air motion. The Position sensor 5D can also be used to determine how much light is hitting the subjects, and therefore how much warmth they may be receiving from the light source. Information from these sensors can be used to tell the Processing and Memory 5C how much heat to output both when the heater turns on and as time and conditions change after the heater is on.

User Control 5I is useful for improved comfort. Because different targets may prefer different amounts of heat, it is useful to have controls that indicate “more heat desired” and “less heat desired.” This is advantageous because a system with multiple heaters can provide different amounts of heat to different targets at the same time, regardless of their distances. A target requesting heat may control the heater by gestures that can be picked-up by the position-sensing camera. IRDA or radio remote controllers may also be used.

The Power Supply 5A should supply the Laser(s) 1, the electronics (5B-5H), the Pointing Mechanism 3, and the Thermal Management 4. The lasers are high-current, low-voltage devices, and so if multiple lasers will be ganged, it will be more cost-efficient and energy-efficient to put multiple lasers in series rather than in parallel.

Algorithm 5E is shown as part of the electronics, but it is likely to be primarily software. The major functions of the control algorithms are: 1) Detecting targets; 2) Pointing the laser at the targets; 3) Controlling the laser, including maintaining safety margins on power density; 4) Responding to user requests for higher or lower heat; 5) Maintaining comfort by outputting the heat in accordance with the characteristics of the target, the target's prior preferences, the ambient temperature, and the amount of air flow. Laser emissions are regulated, and it is necessary to assure that the laser power density does not exceed the regulated limits. It is particularly useful for Algorithm 5E to turn off the heater when no target is within its target area.

These items are a superset of the invention. A very good heater can be made for a non-moving target with a thermal laser and appropriate optics. For a target that may move around, a heater with more of the items in this schematic is useful. Similarly, for greater comfort and efficiency, additional items are useful.

FIG. 2A shows outline drawings of the device, while FIG. 2B shows the same device with dashed-line views.

The output from Laser(s) 1A must be mounted centered behind the collimator. The main consideration of optics in the packaging is how the beam as it exits the package will interact with the Optics 2 to create a generally uniform and collimated beam. The choices are driven primarily by the fact that the lateral (“slow”) axis of high powered'lasers is multimode and has a divergence around 8 degrees FWHM, while the vertical (“fast”) axis is single mode and has a divergence of 35 degrees FWHM. How the lasers are packaged can substantially affect performance. For example, beam circularizing cylindrical lenses, various kinds of reflectors, and various kinds of beam combiners can be packaged with (or external to) the lasers. The Laser(s) 1A must be packaged to stop moisture from getting to the lasers. Many mounting schemes can be used, depending on the thermal requirements and the design of the optics.

Optics 2 shows a Fresnel on the front of an enclosure. This is a simple approach because the Fresnel serves as both an optic and a front cover. More complex optics could be used as well. Reflecting optics could be used to expand and collimate, but they would still require a glass cover. Microlenses can be used to circularize the beam. A concave lens can be used to reduce the length of the system. In this design, there is one beam. If the lasers are not combined into a single beam, it may be useful to have several separate collimated beams rather than one large collimated beam.

Pointing Mechanism 3 is a two-axis pan-and-tilt driven by two stepper motors with inline gear trains. The drive electronics are in Electronics 5F. Other arrangements can be used. The main concern is with the specification of resolution. Assume that the resolution specification is 20 mm at a range of 20 m. This corresponds to a 0.001 radian tolerance. Assume the stepper motor tolerance is 10 degrees per step. That gear train would need 100 to 1 ratio.

Thermal Management 4—shown as fan on radiator is shown. A fan on heat pipes would work for some cases. Lasers perform at 25° C. and generally performance decreases as they get hotter by perhaps 1.5%/° C. Because most people who use a heater are in a colder environment than 25° C. and those who want a lot of heat are usually in a colder (or windier) environment, it should not in general be necessary to provide refrigeration or thermoelectric cooling. Thermoelectric cooling can be useful because it has no moving parts and is quiet.

Electronics 5 consists of the items as shown. All of the components are commercially available. The electronics will need to be mounted out-of-the-way near the front of the enclosure to provide a good field-of-view to the sensors. Because these heaters may be used outside, an enclosure that will assure dryness may be valuable.

The system as shown above has many parts. It is possible to make an excellent heater for some circumstances with a subset of these parts. For example, a stand-alone heater would not need Communications 5B, but a heater for use in a public space with multiple targets and multiple heaters might benefit from Communications 5B. Similarly, a person sitting in a car will not move much, and he might be heated from the ceiling or the seat-back in front of him with a fixed heater comprising only Lasers 1A, Packaging 1B and Thermal Management 4, and Optics 2.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention

From the above description the advantages can be easily seen. A heater with a thermal laser as the heating element can be far more efficient than existing heaters because a far higher proportion of the photons hit the target, especially when the target is not near the heater. It can also be more comfortable because the targeting is so fine that it is possible to heat different parts of the body differently. Targeting also improves comfort because the targeting sensors can provide data on who the target is and what conditions they may prefer. In general, existing heaters send photons into space promiscuously, while the heater of this invention sends photons in a precisely controlled direction, usually at a known target.

I claim:

1. A heater for the comfort and homeostasis of people and animals comprising a laser as a heating element.

2. The heater of claim 1 where the wavelength of the thermal laser is greater than 1199 nm.

3. The heater of claim 1 comprising an optic or optical system shaping the beam so that a high proportion of the photons impinge upon the target and the power density of the photons is within safety limits at the target.

4. A heater of claim 3 in which the optical system shapes the beam so the beam's power density exits the optic below safety limits and remains below safety limits throughout its travel.

5. The heater of claim 4 comprising an optical system that expands the beam such that the beam's power density exits the optic above safety limits but the beam's power density reaches safety limits at the distance of the target.

6. The heater of claim 5 in which a computer reduces the power density in the beam when sensors notify it that a person is in or near where the power density in the beam is above the safety limit.

7. The heater of claim 3 also comprising a mechanical mount to point the beam emerging from the optic.

8. The heater of claim 7 in which the mechanical mount is moved by at least 1 motor.

9. The heater of claim 8 in which the motor is controlled by a computer.

10. The heater of claim 3 in which a sensor determines the distance to the target or the position of the target.

11. The heater of claim 10 where the sensor is an imager

12. The heater of claim 10 in which a sensor discriminates between the different parts of the body of the target person or animal.

13. The heater of claim 3 in which a sensor discriminates between the exposed skin of the target person or animal and the areas masked by clothing or objects.

14. The heater of claim 11 in which the software allows the target to control the heater with a gesture.

15. The heater of claim 11 in which the heater recognizes different individuals as targets.

16. The heater of claim 15 in which the heater can preset an individual's preferred comfort level for beam power density.

17. The heater of claim 11 in which the heater discerns the age, gender, or species of the target and presets the beam power density accordingly.

18. The heater of claim 3 which also comprises:
a. A motorized pointing system
b. A sensor that acquires more than one target
c. Software that directs the heater to heat more than one target by healing targets one after another in sequence.

19. The heater of claim 3 which further comprises:
a. A motorized pointing system
b. A sensor that acquires more than one target
c. Software software and communication electronics that coordinate its targeting with other heaters.

19. The heater of claim 3 which uses a mirror to redirect the heat.

20. The heater of claim 3 which senses ambient temperature and/or air flow and increases or decrease the heat automatically in response to data on ambient conditions.
